(19) United States
(12) Patent Application Publication
(10) Pub. No.: US 2019/0194973 A1
(43) Pub. Date: Jun. 27, 2019

(54) LOCK

(71) Applicant: TA-HUNG CHENG, Changhua County (TW)

(72) Inventor: TA-HUNG CHENG, Changhua County (TW)

(21) Appl. No.: 15/851,670

(22) Filed: Dec. 21, 2017

(51) Int. Cl. E05B 3/06; E05B 41/00; E05B 13/00; E05B 15/00; E05B 3/00; E05B 1/00

(52) U.S. Cl. CPC E05B 3/065; E05B 41/00; E05B 13/004; E05B 1/0053; E05B 3/003; E05B 1/003; E05B 15/0033

(57) ABSTRACT

A lock includes: a drive unit with a first rotatable connecting member, an opposite second rotatable connecting member, and a drive member; a press member disposed in the first rotatable connecting member; a first sleeve sleeved onto the first rotatable connecting member and including a first positioning groove; a second sleeve sleeved onto the second rotatable connecting member and including a second positioning groove; a first spring disposed in the first positioning groove and having two ends; a second spring disposed in the second positioning groove and having two ends; a first horizontal lever sleeved onto the first rotatable connecting member; and a second horizontal lever sleeved onto the second rotatable connecting member. The lock is improved in durability and service life, can be easily locked pressing the pressing member, and allows a user to tell by appearance whether the lock is locked or not.

### BACKGROUND OF THE INVENTION

### Field of the Invention

The present invention relates to a lock, and more particularly to a lever lock.

### Related Prior Art

Locks generally include knob locks and lever locks, which can find wide application in rooms, offices, dressing room, etc. The knob locks are easy to install on a door and to operate. Although knob locks are easy for a user to grip and rotate, they still have the following disadvantages.

As shown in FIG. 1, which is an exploded view of a knob lock 80 disclosed in Taiwan Patent No. M527903, the knob lock 80 includes two handles 81, a positioning structure 82, a lock cylinder 83, an actuating structure 84 and a telescopic structure 85. Each of the handles 81 is a unitary structure, and includes a protrusion 811 at one end and a hole 812 at another. The protrusion 811 is a hollow and aligned with the hole 812. The positioning structure 82 includes two positioning discs 821, a cover 822, an assembling member 823, a threaded sleeve 824, a U-shaped plate a first fixing plate 826, a spring-fixing portion 827, and a second fixing plate 828. The positioning discs 821 are fixed to the protrusions 811 of the handles 81. The cover 822 is provided for insertion of the assembling member 823 which is fixed to one end of the U-shaped plate 825. The threaded sleeve 824, the U-shaped plate 825 and the first fixing plate 826 are connected to one another. The spring-fixing portion 827 is formed on the U-shaped plate 825. The second fixing plate 828 is fixed to the U-shaped plate 825.

The lock cylinder 83 includes a fixing member 831, a first connecting sleeve 832, a drive member 833, a tongue 834, a second connecting sleeve 835, and a press assembly 836. The fixing member 831 is disposed in one of the handles 81. The first connecting sleeve 832 has two ends sleeved onto the fixing member 831 and the drive member 833, respectively. The first connecting sleeve 832 of the lock cylinder 83 and the positioning structure 82 of the U-shaped plate 825 mutually restrict each other's freedom of action. The drive member 833 and the fixing member 831 are assembled together within the first connecting sleeve 832. The tongue 834 is connected to the drive member 833. The second connecting sleeve 835 has two ends connected to the tongue 834 and the press assembly 836, respectively. The press assembly 836 is disposed in another of the handles 81, and includes a connecting portion 8361, a C-shaped piece 8362 and an upper cover 8363 which are assembled together for insertion of the tongue 834.

The actuating structure 84 includes at least one spring 841, a spring-stop portion 842, a first connecting portion 843 and a second connecting portion 844. The spring 841 has two ends fixed to the spring-fixing portion 827 and the spring-stop portion 842, respectively. The spring-stop portion 842 is disposed on the first connecting portion 843 which is connected to the second connecting portion 844.

The handles 81 of the abovementioned knob lock 80 are knobs, so that it is inconvenient for a user with hands full of items to open the door since he/she has to put the items down in order to rotate the knob handle 81. If the lock is a lever lock 9, as shown in FIG. 9, the user can easily open the door by simply pushing the lever down, and this is the function that the knob lock 80 cannot achieve. Besides, the knob lock 80 is quite difficult for those who are old or with injured hands to grab and rotate, and the lever lock 90 is easier to operate than the knob lock 80. Therefore, the lever lock 90 becomes indispensable to the daily life of those who are old or with injured hands.

Most of the lever locks 90 are provides with a rotary button to lock the inner components to prevent unlocking from outside. However, the user cannot tell by appearance whether the inner components are locked or not, therefore, the user often forgets to lock the door or has to find the locking direction from another end of the door handle, which causes inconveniences in use. Besides, the rotary button is very small and therefore difficult to operate, and the location of force application is too close to the frame of the door, which will cause interference with the user's hands.

Furthermore, the internal structure of the lever lock 90 is complicated, and the spring (not shown) inside the lever lock 90 will become fatigue after long time of use, causing loosening of the inner components, so that the lever of the lever lock 90 cannot be maintained parallel to the floor, which makes the lever lock 90 inconvenient to use, and therefore reduces the life of the lever lock 90.

The present invention has arisen to mitigate and/or obviate the afore-described disadvantages.

### SUMMARY

One objective of the present invention is to provide a lock which is durable and can be effortlessly pressing a press member, and allows the user to tell by appearance whether the lock is locked or not.

To achieve the above objective, a lock provided by the invention comprises:

a drive unit including a first rotatable connecting member, a second rotatable connecting member opposite the first rotatable connecting member, and a drive member connected between the first and second rotatable connecting members, the drive member including a first drive portion connected to and driven to rotate by the first rotatable connecting member, and a second drive portion connected to and driven to move by the second rotatable connecting member;

a press member disposed in the first rotatable connecting member in a pressable manner and connected to the drive member;

a first sleeve sleeved onto the first rotatable connecting member to fix the drive member, and including a first engaging surface for fixing the drive member, and a first positioning groove formed in the first engaging surface, the first positioning groove including a first fixing hole, a first positioning hole, and a first positioning portion surrounding the first fixing hole and the first positioning hole;

a second sleeve sleeved onto the second rotatable connecting member to fix the drive member, and including: a second engaging surface for fixing the drive member, and a second positioning groove formed in the second engaging surface, the second positioning groove including a second fixing hole, a second positioning hole, and a second positioning portion surrounding the second fixing hole and the second positioning hole;

a first spring including a first expansion portion disposed in the first positioning groove and driven to move by the first rotatable connecting member, a first end inserted in the first fixing hole and driven to move by the first drive portion, and a second end inserted in the first positioning hole and driven to move by the first drive portion;

a second spring including a second expansion portion disposed in the second positioning groove and driven to move by the second rotatable connecting member, a first end inserted in the second fixing hole and driven to move by the second drive portion, and a second end inserted in the second positioning hole and driven to move by the second drive portion;

a first horizontal lever sleeved onto and driven to rotate by the first rotatable connecting member, and including: a first assembling portion to be connected to the first rotatable connecting member, and a first gripping portion extended from the first assembling portion and to be pressed by a user, the first assembling portion including an insertion hole for insertion of the first rotatable connecting member and the press member; and

a second horizontal lever sleeved onto and driven to rotate by the second rotatable connecting member, and including: a second assembling portion connected to the second rotatable connecting member, and a second gripping portion extended from the second assembling portion and to be pressed by the user.

Preferably, a first cover is disposed between the first assembling portion and the first sleeve, and includes a first threaded portion meshed with a first threaded portion of the first sleeve.

Preferably, a second cover is disposed between the second assembling portion and the second sleeve, and includes a second threaded portion to be meshed with a second threaded portion of the second sleeve.

Preferably, the first positioning groove includes a first insertion hole for insertion of the first rotatable connecting member.

Preferably, the second positioning groove includes a second insertion hole for insertion of the second rotatable connecting member.

The present invention has the following advantages over the conventional lock: firstly, the first and second horizontal levers are horizontally arranged and each are provided with a gripping portion which can be gripped and rotated easily by a user. Secondly, the press member is disposed in the first rotatable connecting member in a pressable manner, which allows the user to tell by appearance whether the lock is locked or not. Thirdly, two springs are disposed in the positioning grooves of the two sleeves, which improve not only the structure but also the service life of the lock.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view of a conventional knob lock;

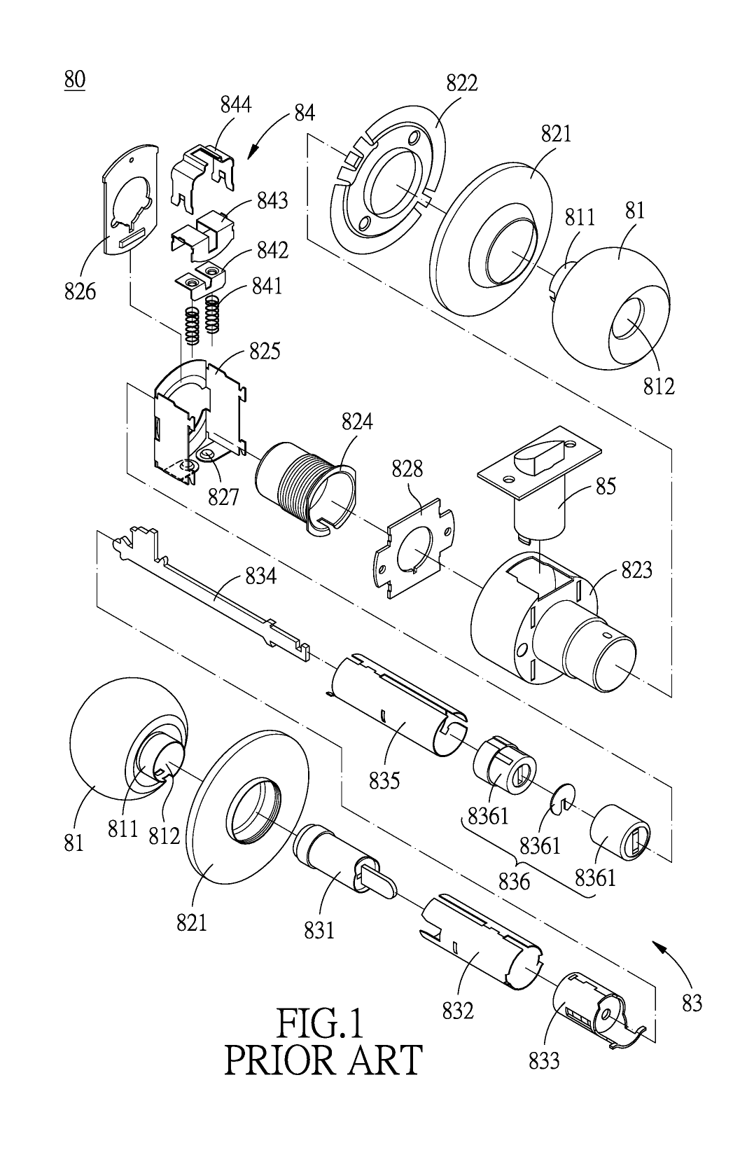

FIG. 2 shows a conventional lever lock;

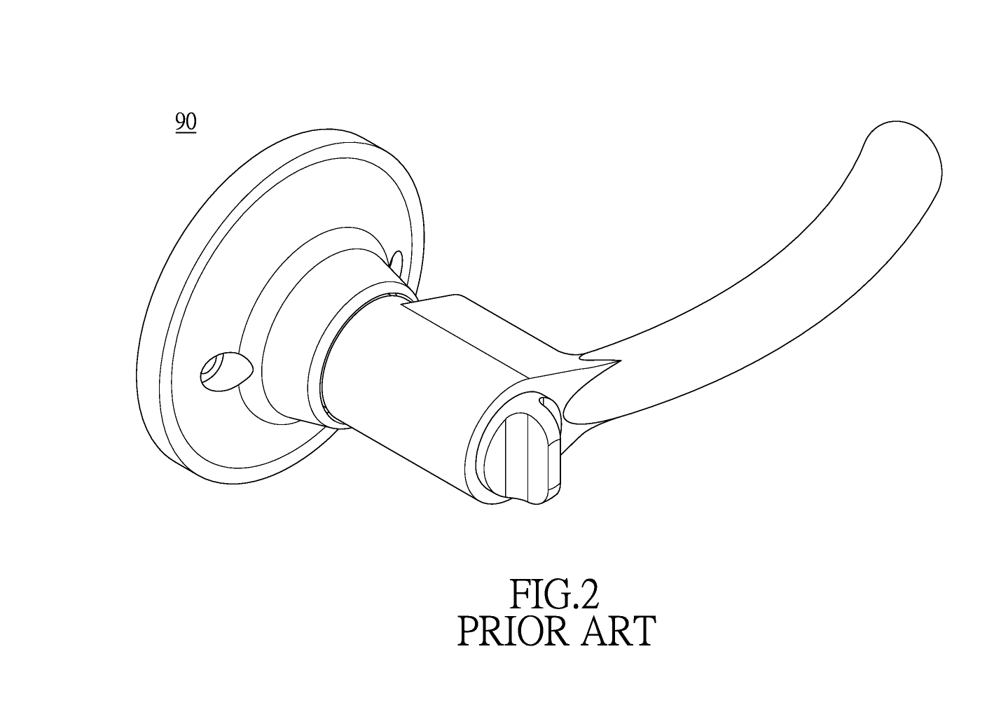

FIG. 3 is a perspective view of the lock in accordance with a preferred embodiment of the invention;

FIG. 4 is an exploded view of the lock in accordance with the invention;

FIG. 5 is a perspective view of the lock in accordance with a preferred embodiment of the invention; and

FIG. 6 is an operational view of the invention showing that the spring is being driven to rotate.

### DETAILED DESCRIPTION

The present invention will be clearer from the following description when viewed together with the accompanying drawings, which show, for purpose of illustrations only, the preferred embodiment in accordance with the present invention.

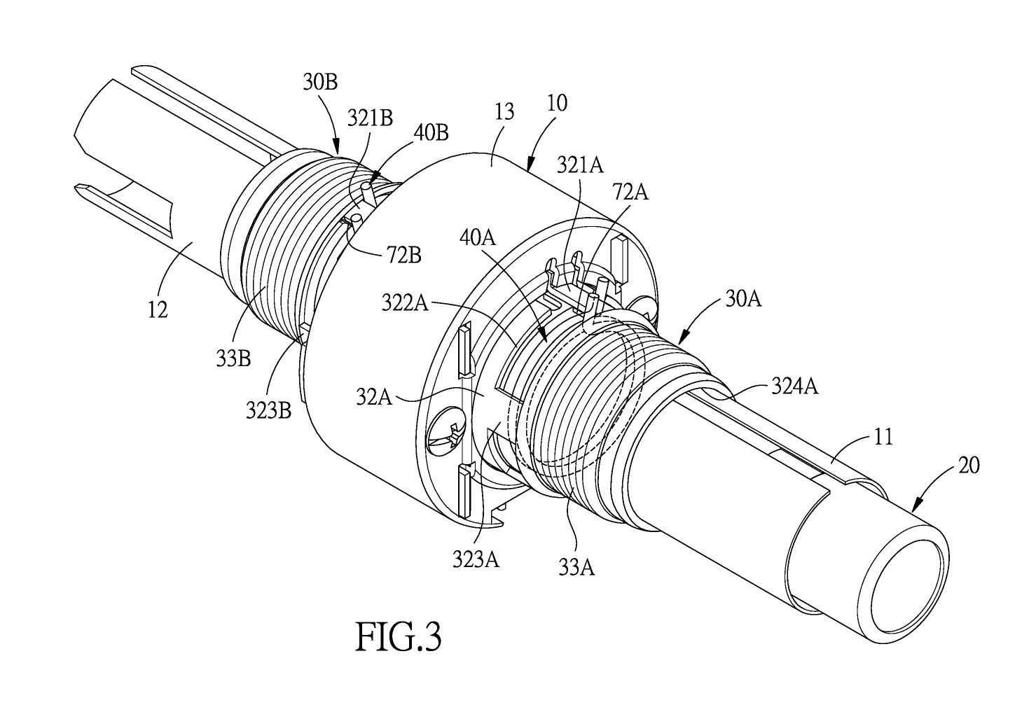

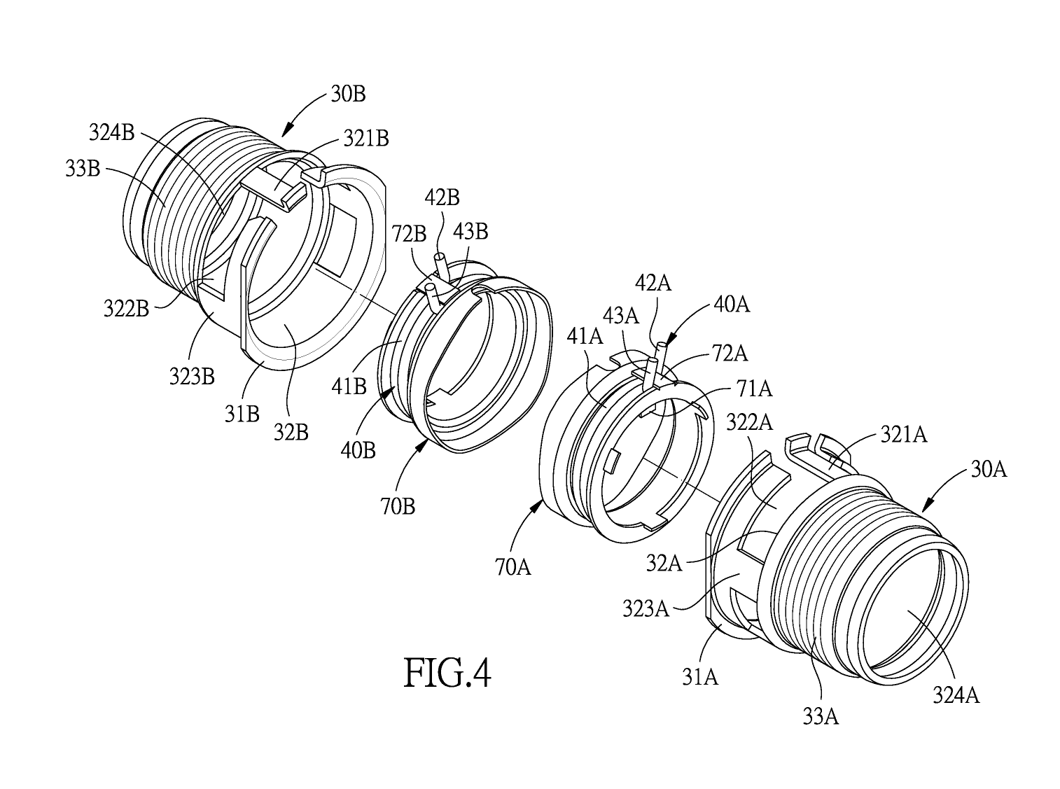

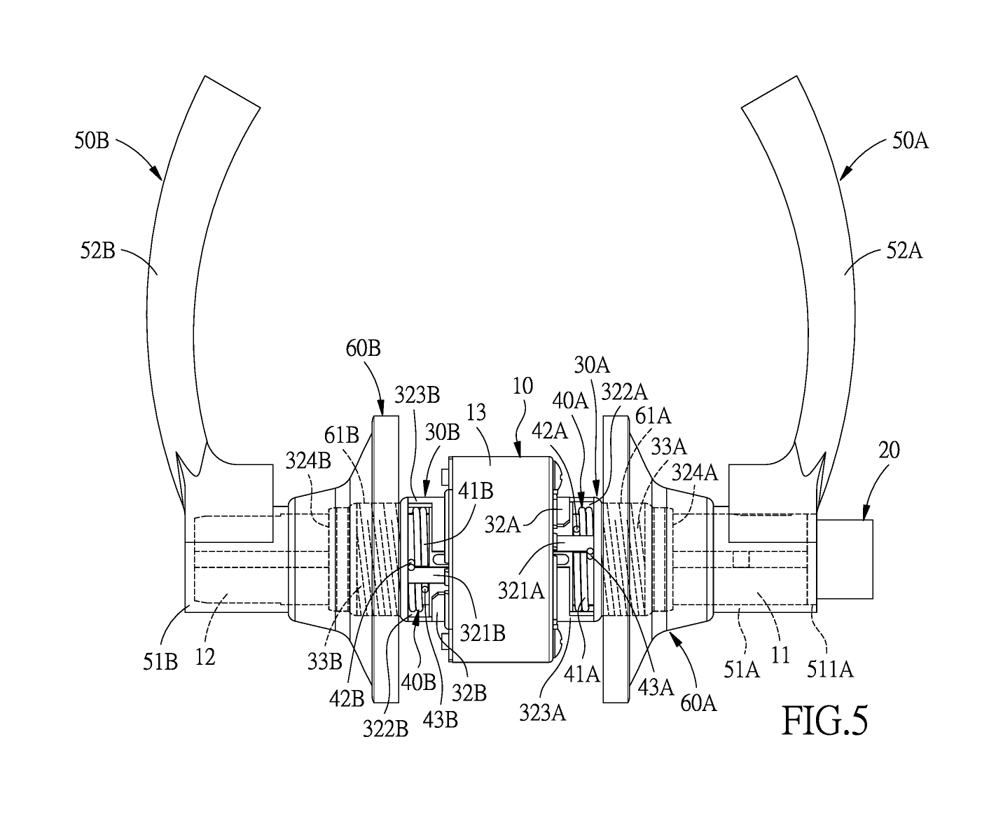

Referring to FIGS. 3-5, a lock 200 in accordance with the preferred embodiment of the invention comprises: a drive unit 10, a press member 20, a first sleeve 30A, a second sleeve 30B, a first spring 40A, a second spring 40B, a first horizontal lever 50A, a second horizontal lever 50B, a first cover 60A and a second cover 60B.

The drive unit 10 includes a first rotatable connecting member 11, a second rotatable connecting member 12 opposite the first rotatable connecting member 11, and a drive member 13 connected between the first and second rotatable connecting members 11, 12. The drive member 13 includes a first drive portion connected to and driven to rotate by the first rotatable connecting member, and a second drive portion connected to and driven to move by the second rotatable connecting member 12. The detailed interior structure of the drive member 13 is conventional, and therefore further description has been omitted.

The press member 20 is disposed in a pressable manner in the first rotatable connecting member 11 and connected to the drive member 13. When the press member 20 is pressed down, the drive member 13 will be fixed by the internal components of the lock, so that the lock is locked in a locked position (not shown), so that the user can easily tell by appearance whether the locked is locked or not, and the lock is very easy to operate.

The first sleeve 30A is sleeved onto the first rotatable connecting member 11 to fix the drive member 13, and includes a first engaging surface 31A for fixing the drive member 13, and a first positioning groove 32A formed in the first engaging surface 31A. The first positioning groove 32A includes a first fixing hole 321A, a first positioning hole 322A, a first positioning portion 323A surrounding the first fixing hole 321A and the first positioning hole 322A, and a first insertion hole 324A for insertion of the first rotatable connecting member 11. Besides, the first sleeve 30A includes a first threaded portion 33A formed on an outer surface thereof.

The second sleeve 30B is sleeved onto the second rotatable connecting member 12 to fix the drive member 13, and includes: a second engaging surface 31B for fixing the drive member 13, and a second positioning groove 32B formed in the second engaging surface 31B. The second positioning groove 32B includes a second fixing hole 321B, a second positioning hole 322B, a second positioning portion 323B surrounding the second fixing hole 321B and the second positioning hole 322B, and a second insertion hole 324B for insertion of the second rotatable connecting member 12. Besides, the second sleeve 30B is provided on an outer surface thereof with a second threaded portion 33B.

The first spring 40A includes a first expansion portion 41A disposed in the first positioning groove 32A and driven to move by the first rotatable connecting member 11, a first end 42A inserted in the first fixing hole 321A and driven to move by the first drive portion, and a second end 43A inserted in the first positioning hole 322A and driven to move by the first drive portion. Besides, the first spring 40A is sleeved onto a first engaging member 70A which is disposed in the first positioning groove 32A, and the first engaging member 70A includes a first engaging portion 71A for engaging with the first rotatable connecting member 11.

The second spring 40B includes a second expansion portion 41B disposed in the second positioning groove 32B and driven to move by the second rotatable connecting member 12, a first end 42B inserted in the second fixing hole 321B and driven to move by the second drive portion, and a second end 43B inserted in the second positioning hole 322B and driven to move by the second drive portion. Besides, the second spring 40B is sleeved onto a second engaging member 70B which is disposed in the second positioning groove 32B, and the second engaging member 70B includes a second engaging portion 71B for engaging with the second rotatable connecting member 12.

The first horizontal lever 50A is sleeved onto and driven to rotate by the first rotatable connecting member 11, and includes: a first assembling portion 51A to be connected to the first rotatable connecting member 11, and a first gripping portion 52A extended from the first assembling portion 51A and to be pressed by a user. The first assembling portion 51A includes an insertion hole 511A for insertion of the first rotatable connecting member 11 and the press member 20.

The second horizontal lever 50B is sleeved onto and driven to rotate by the second rotatable connecting member 12, and includes: a second assembling portion 51B connected to the second rotatable connecting member 12, and a second gripping portion 52B extended from the second assembling portion 51B and to be pressed by a user.

The first cover 60A is disposed between the first assembling portion 51A and the first sleeve 30A, and includes a first threaded portion 61A meshed with the first threaded portion 33A of the first sleeve 30A.

The second cover 60B is disposed between the second assembling portion 51B and the second sleeve 30B, and includes a second threaded portion 61B to be meshed with the second threaded portion 33B of the second sleeve 30B.

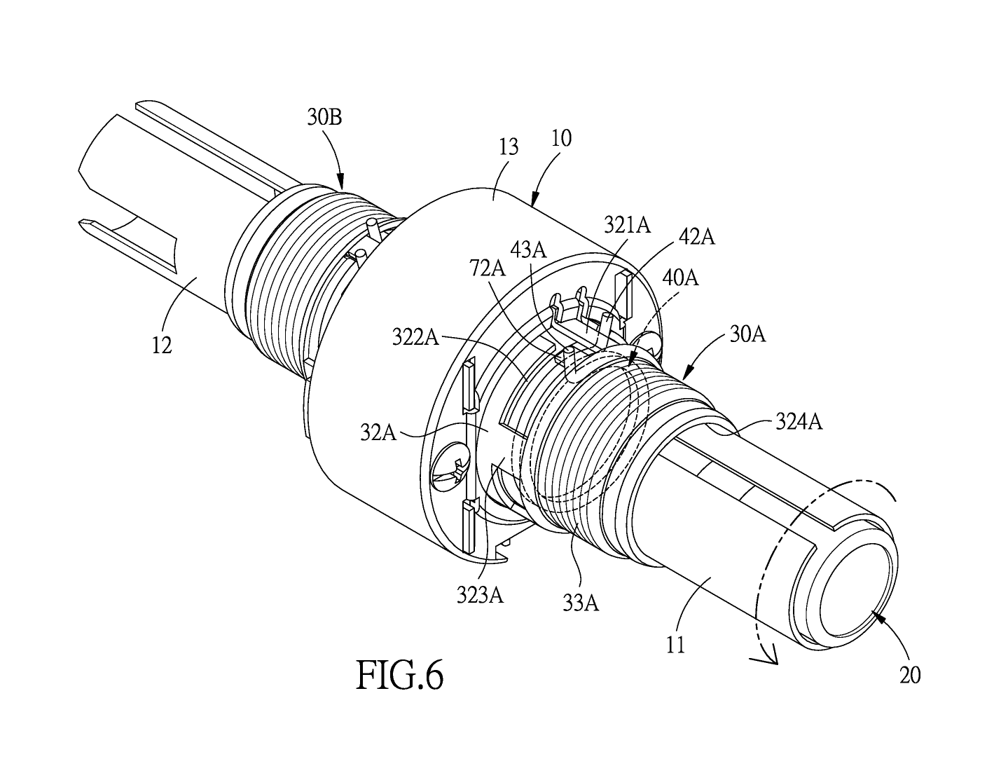

As shown in FIG. 6, when the first rotatable connecting member 11 is rotated counterclockwise by a user (which is for exemplary only but not for limiting purpose, and the first rotatable connecting member 11 can also be rotated clockwise), the first drive portion of the drive member 13 will be driven to rotate together with the first rotatable connecting member 11, then the second end 43A of the first spring 40A will be driven by the first drive portion to move away from the first positioning portion 323A. The spring (not shown) of the conventional lever lock will become fatigue after long time of use, causing loosening of the inner components. Therefore, with the design of the invention, the two springs (the first spring 40A and the second spring 40B) are disposed in the positioning grooves of the two sleeves (the first sleeve 30A and the second sleeve 30B), so that the whole structural strength is increased to improve the durability and service life of the lock of the invention. The user can also rotate the second rotatable connecting member 12 in clockwise or counterclockwise direction by the same method as mentioned above, and therefore, further description is omitted.

What mentioned above are the structural relations of the respective components of the invention, and the advantages of the invention are explained as follows:

Firstly, service life is prolonged. The spring of the conventional lever lock will be fatigued after a period time of use, so that the lever of the lever lock cannot be maintained parallel to the floor. The invention solves the above problem by providing two springs (the first spring 40A and the second spring 40B) onto the two sleeves (the first sleeve 30A and the second sleeve 30B), so that the whole structural strength is increased to improve the durability and service life of the lock of the invention.

Secondly, locking by pressing, since the conventional lever lock is locked by rotating the rotary button, the user cannot tell by appearance whether the lock is locked or not. Besides, the rotary button is too small and therefore difficult to operate. The invention solves the above problem by providing the press member 20 in a pressable manner in the first rotatable connecting member 11, so that the user can easily tell by appearance whether the lock is locked or not (by checking if the press member 20 is pressed or not), and pressing the press member is easier than rotating the rotary button. Besides, locking by rotating the rotary button has the problem that the location of force application is too close to the frame of the door, which will cause interference with the user's hand, and the invention has solved this problem by changing the way of locking by rotating to locking by pressing or pushing (the press member).

Thirdly, horizontally maintained levers, the handle of the conventional knob lock is a knob and therefore quite difficult for those who are old or with injured hands to grab and rotate. The first and second horizontal levers 50A, 50B are maintained in parallel to the floor, and the lock can easily be unlocked by slightly pressing the first or second gripping portion 52A, 52B, which is the best choice for those who need a crutch or those with disability.

While we have shown and described various embodiments in accordance with the present invention, it is clear to those skilled in the art that further embodiments may be made without departing from the scope of the present invention.

What is claimed is:

1. A lock comprising:
a drive unit including a first rotatable connecting member, a second rotatable connecting member opposite the first rotatable connecting member, and a drive member connected between the first and second rotatable connecting members, the drive member including a first drive portion connected to and driven to rotate by the first rotatable connecting member, and a second drive portion connected to and driven to move by the second rotatable connecting member;
a press member disposed in the first rotatable connecting member in a pressable manner and connected to the drive member;
a first sleeve sleeved onto the first rotatable connecting member to fix the drive member, and including a first engaging surface for fixing the drive member, and a first positioning groove formed in the first engaging surface, the first positioning groove including a first fixing hole, a first positioning hole, and a first positioning portion surrounding the first fixing hole and the first positioning hole;
a second sleeve sleeved onto the second rotatable connecting member to fix the drive member, and including: a second engaging surface for fixing the drive member, and a second positioning groove formed in the second engaging surface, the second positioning groove including a second fixing hole, a second positioning hole, and a second positioning portion surrounding the second fixing hole and the second positioning hole;
a first spring including a first expansion portion disposed in the first positioning groove and driven to move by the first rotatable connecting member, a first end inserted in the first fixing hole and driven to move by the first drive portion, and a second end inserted in the first positioning hole and driven to move by the first drive portion;
a second spring including a second expansion portion disposed in the second positioning groove and driven to move by the second rotatable connecting member, a first end inserted in the second fixing hole and driven to move by the second drive portion, and a second end inserted in the second positioning hole and driven to move by the second drive portion;
a first horizontal lever sleeved onto and driven to rotate by the first rotatable connecting member, and including: a first assembling portion to be connected to the first rotatable connecting member, and a first gripping portion extended from the first assembling portion and to be pressed by a user, the first assembling portion including an insertion hole for insertion of the first rotatable connecting member and the press member; and
a second horizontal lever sleeved onto and driven to rotate by the second rotatable connecting member, and including: a second assembling portion connected to the second rotatable connecting member, and a second gripping portion extended from the second assembling portion and to be pressed by the user.

2. The lock as claimed in claim 1 further comprising a first cover which is disposed between the first assembling portion and the first sleeve, and includes a first threaded portion meshed with a first threaded portion of the first sleeve.

3. The lock as claimed in claim 1 further comprising a second cover which is disposed between the second assembling portion and the second sleeve, and includes a second threaded portion to be meshed with a second threaded portion of the second sleeve.

4. The lock as claimed in claim 1, wherein the first positioning groove includes a first insertion hole for insertion of the first rotatable connecting member.

5. The lock as claimed in claim 1, wherein the second positioning groove includes a second insertion hole for insertion of the second rotatable connecting member.
